(19) United States
(12) Patent Application Publication
(10) Pub. No.: US 2023/0268573 A1
(43) Pub. Date: Aug. 24, 2023

(54) SYSTEMS AND METHODS FOR RECOVERING METALS FROM RECYCLED ELECTRICAL ENERGY STORAGE DEVICES

(71) Applicant: CERIUM LABORATORIES LLC, Austin, TX (US)

(72) Inventors: Tim Hossain, Austin, TX (US); Mike Benjamin, Austin, TX (US); Will Flanagan, Austin, TX (US)

(21) Appl. No.: 18/108,463

(22) Filed: Feb. 10, 2023

Related U.S. Application Data
(60) Provisional application No. 63/308,821, filed on Feb. 10, 2022.

(51) Int. Cl. H01M 10/54; C25D 3/12; C22B 7/00; C22B 3/00; C23C 18/32

(52) U.S. Cl. CPC H01M 10/54; C25D 3/12; C22B 7/007; C22B 23/0415; C23C 18/32; C22B 1/005

(57) ABSTRACT

A method for recycling an electrical energy storage device includes exposing components of the electrical energy storage device to an acidic solution to form a recovery solution; performing plating in the presence of the recovery solution and a conductive substrate, metals of the recovery solution depositing on the conductive substrate; and oxidizing the metals deposited on the conductive substrate to form an electrode material.

### CROSS-REFERENCE TO RELATED APPLICATION(S)

This application claims benefit of U.S. Provisional Application No. 63/308,821, filed Feb. 10, 2022, which is incorporated herein by reference in its entirety.

### BACKGROUND

Electrical energy storage devices, such as batteries, capacitors, or hybrids thereof, are increasingly being used in a variety of products. In particular, rechargeable variations of electrical energy storage devices are being used in cell phones, smart watches, power tools, and electric vehicles, among many other products. However, each of these electrical energy storage devices has a limited lifetime. For example, rechargeable electrical energy storage devices are rated for a set number of recharge cycles.

Such electrical energy storage devices generally are made with metals, often in the form of metal ions or metal oxides. Some such metals pose an environmental hazard if disposed of in, for example, landfills. Other such metals are valuable in the marketplace and expensive to replace.

As such, an improved method for recovering metals from recycled electrical energy storage devices would be desirable.

### BRIEF DESCRIPTION OF THE DRAWINGS

The present disclosure may be better understood, and its numerous features and advantages made apparent to those skilled in the art by referencing the accompanying drawings.

FIG. 1 includes a block flow diagram illustrating an example method for recovering metals from electrical energy storage devices.

FIG. 2 and FIG. 3 include illustrations of example galvanic cells.

FIG. 4 includes a graph of an energy dispersive x-ray microanalysis of an example electrode.

The use of the same reference symbols in different drawings indicates similar or identical items.

### DETAILED DESCRIPTION

In an embodiment, a method for recovering metals from recycled electrical energy storage devices includes exposing components of the electrical energy storage device to an acid solution to form a recovery solution, performing plating using the recovery solution to deposit metals on a conductive substrate, and oxidizing the deposited metals on the conductive substrate to form an electrode. In an example, the acid solution can be a solution including aqua regia having a pH of less than 1. In another example, the components of the electrical energy storage device can be heated in an inert atmosphere, such as at a temperature in a range of 200° C. to 1200° C. for a period in a range of 30 minutes to 10 hours. In an additional example, the components of the electrical energy storage device can be mechanically reduced either prior to heating or following heating. In an example, the plating is electroless. In a further example, plating can be performed in a galvanic cell including two half-cells connected by a salt bridge. For example, the galvanic cell can be free of an external voltage source. A zinc anode can be disposed in one of the half-cells, and a conductive substrate, such as a metal foil or graphite, can be used as a cathode in the other half-cell.

Electrical energy storage devices utilize different metal chemistries to form anodes and cathodes. For example, various lithium-ion technologies utilize cathodes formed of oxides of lithium, aluminum, cobalt, nickel, manganese, iron, titanium, phosphorus, or various combinations thereof. For example, cathodes are formed of lithium nickel manganese cobalt oxide, lithium nickel cobalt aluminum oxide, lithium manganese oxide, lithium iron phosphate, lithium cobalt oxide, or lithium nickel cobalt oxide, among others. Example anodes are formed with graphite, lithium titanate, carbon, tin/cobalt alloys, or silicon/carbon nanowires. Recovery of the associated metals would be desirable both from an environmental perspective and for efficient recycling of materials.

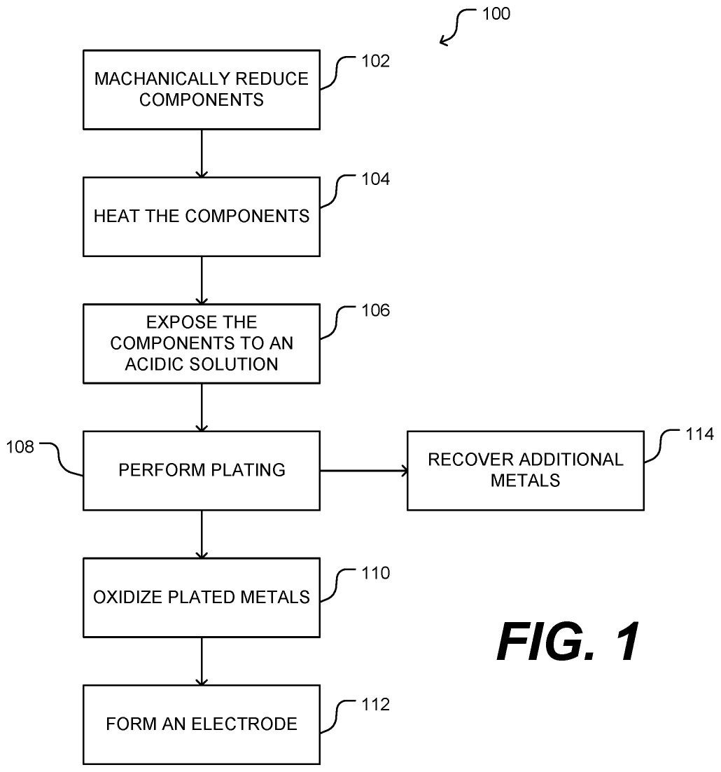

FIG. 1 illustrates an example method 100 for recovering metals from components of electrical energy storage devices. As illustrated at block 102, the components can be mechanically reduced, such as through grinding, cutting, pulverizing, or other methods, to increase surface area for further processing. For example, the components such as electrodes, including anodes and cathodes, and electrolyte or ion-transfer medium within the electrical energy storage device can be mechanically reduced. Mechanical reduction is illustrated as occurring before heating components of the electrical energy storage device. Alternatively, mechanical reducing can be performed following heating components of the electrical energy storage device.

As illustrated at block 104, the components of the electrical energy storage device can be heated in a furnace. For example, the components can be heated in a furnace under an inert atmosphere. In an example, the inert atmosphere includes nitrogen, argon, or a combination thereof. For example, heating can include heating at a temperature in a range of 200° C. to 1200° C., for example, 200° C. to 1000° C., such as a range of 350° C. to 1000° C., a range of 350° C. to 900° C., or range of 500° C. to 900° C. In a further example, the temperature range can be 600° C. to 1200° C., such as 800° C. to 1200° C. Heating can be performed for a period in a range of 30 minutes to 10 hours, such as a range of 1 hour to 10 hours or a range of 2 hours to 9 hours. In a particular example, heating is performed in a muffle furnace.

The components of the electrical energy storage device can further be exposed to an acidic solution to form a recovery solution. For example, after heating, metals and metal oxides can be dissolved in the acidic solution to provide a recovery solution including metal ions, as illustrated at block 106. In an example, the acidic solution includes aqua regia, hydrochloric acid, sulfuric acid, nitric acid, or a combination thereof. In a particular example, the acidic solution includes aqua regia. In another example, the acid solution includes nitric acid. In an example, the acidic solution has a pH of less than 1.5, such as a pH of less than 1 or less than 0.5.

Optionally, the recovery solution can be filtered. For example, the recovery solution can be filtered through a ceramic or polymeric filter. Further, the pH of the recovery solution can be adjusted. For example, the pH of the recovery solution can be adjusted to a range of 5.5 to 8.0, such as 6.0 to 8.0 or 6.5 to 7.5.

Some metals can be recovered from the recovery solution using plating, as illustrated at block 108. In an example, plating is performed with the recovery solution before precipitation of any metals. For example, the plating can include electroless plating. In an example, the electroless plating includes adding reducing agent to the recovery solution in the presence of a substrate for deposition. For example, the reducing agent can include hypophosphite, borohydride, ammonium, or a combination thereof. The substrate can include a conductive substrate, such as a metal or graphite. In an example, the conductive substrate can be a metal such as copper, gold, silver, platinum, titanium, aluminum, or combinations thereof. In particular, the conductive substrate may be graphite. In another example, the conductive substrate can be a metal, such as a metal foil, for example, an aluminum foil.

In another example, plating can utilize galvanic potentials in the presence of an anode and cathode to reduce metal cations, causing metal deposition on a cathode. For example, the system can perform the plating without the application of an external electrical potential. For example, plating is performed to deposit recovered metals on a conductive substrate. In an example, a conductive substrate can include metal, graphite, or a combination thereof. In an example, the conductive substrate can be a metal such as copper, gold, silver, platinum, titanium, aluminum, or combinations thereof. In particular, the conductive substrate may be graphite. In another example, the conductive substrate can be a metal, such as a metal foil, for example, an aluminum foil.

In a particular example, plating can be performed in a galvanic cell. In an example, the galvanic cell can be free of an external electric potential source. For example, the conductive substrate can form a cathode. The galvanic cell can include an anode. In an example, the anode includes zinc, aluminum, titanium, or combination thereof. In particular, the anode can include zinc. Electroless plating can be performed for 10 minutes to 10 hours, such as a range of 30 minutes to 8 hours or a range of 1 hour to 6 hours. For example, plating can result in a layer thickness of the plated metals in a range of 10 nm to 2 mm, such as a range of 50 nm to 2 mm or a range of 100 nm to 1 mm.

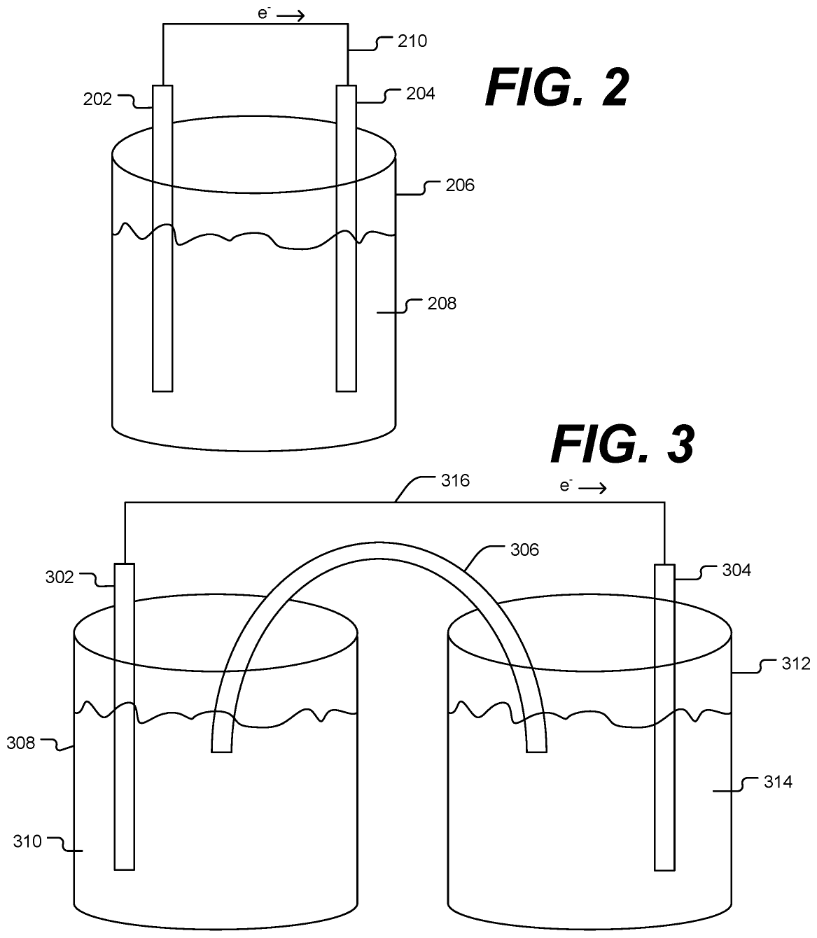

In an example, the galvanic cell can include a single cell galvanic cell. For example, as illustrated in FIG. 2, a single cell galvanic cell includes a container 206, an anode 202, and a cathode 204. The recovery solution 208 is disposed within the container 206 and the anode 202 and cathode 204 are at least partially submerged in the recovery solution 208. The anode 202 and the cathode 204 are electrically connected through, for example, a conductor 210. For example, the anode 202 and the cathode 204 are electrically connected without an external electrical potential source between the anode 202 and the cathode 204.

In another example illustrated in FIG. 3, the galvanic cell can include two half-cells 308 and 312 with a salt bridge 306 in ionic communication between the two half-cells 308 and 312. An anode 302 can be disposed within the half-cell 308. An acidic or salt solution 310 can be disposed within the half-cell 308. For example, a salt or acid solution 310 comprising chlorine, nitrate, or sulfate anion can be disposed within the half-cell 308. The recovery solution 314 can be disposed within the half-cell 312. The salt bridge 306 can include a metal salt, such an alkali or alkali earth metal salt. In an example, the salt bridge 306 includes the same anion associated with the acid or salt solution 310 in the half-cell 308. The salt bridge 306 can include a cation, such as lithium, potassium, sodium, magnesium, or a combination thereof.

The anode 302 is at least partially submerged in the solution 310 and electrically connected via conductor 316 to the cathode 304, which is at least partially submerged in the recovery solution 314. In an example, the anode 302 and the cathode 304 are electrically connected without an external electrical potential source between the anode 302 and the cathode 304. The anode 302 can, for example, be formed of a metal, such as zinc. The cathode 304 can be formed of a conductive substrate such as a metal, graphite, or combination thereof. In a particular example, the cathode 304 is formed of a metal foil, such as aluminum foil. In another example, the cathode 304 is formed of graphite.

Returning to FIG. 1 at block 108, plating utilizes the difference in galvanic potential for various metal components. For example, the use of a zinc anode can result in the plating of cobalt and nickel on the conductive substrate.

| | | |
|---|---|---|
| Ni⁺² + 2e⁻ = Ni | −0.25 | volts |
| Co⁺² + 2e⁻ = Co | −0.28 | volts |
| Zn = Zn⁺² + 2e⁻ | 0.76 | volts |

Alternatively, an electrical potential can be applied between the anode and cathode driving the deposition of other metals or accelerating the deposition of cobalt and nickel.

Additional metal ions can be recovered from the recovery solution, as illustrated at block 114. For example, additional metals can be recovered using precipitation or by the use of electrolysis or electroplating. For example, other materials such as manganese or iron can be precipitated from the remnant of the recovery solution or can be recovered through electroplating. In a further example, lithium can be recovered from the recovery solution using electroplating or precipitation.

As illustrated at block 110, the plated metals can be oxidized. For example, the plated metals can be oxidized in an oxygen containing atmosphere, such as air or an atmosphere including at least 30% oxygen. In an example, oxidizing can be performed at a temperature in a range of 200° C. to 1000° C., such as a range of 350° C. to 900° C. or range of 500° C. to 900° C. Oxidizing can be performed for a period in a range of 10 minutes to 5 hours, such as a range of 30 minutes to 3 hours or a range of 30 minutes to 2 hours. In an example, oxidation can performed in a sleeve to facilitate oxidation from the outside in. Oxidation can be stopped at a time and temperature to limit oxidation of the underlying conductive material, such as aluminum foil or graphite.

As illustrated at block 112, the oxidized plated metals can be used to form a new electrode. For example, the metals can be doped with other metals to form an electrode for use within a battery or capacitor. For example, the electrode can be doped with lithium.

The present process has several advantages over conventional methods. In an example, the process is an environmentally friendly process, for example, no CO2 emission. Both Co, and Ni can be plated simultaneously on a cathode and ready for reuse (after oxidation). Conventional recovery processes obtain Co and Ni using separate chemistry and require a need for a second process to coat an electrode with Co and Ni for forming a cathode; thus, a 2-step operation. The process is less expensive than conventional practices using chemical separation. The plating process can be implemented using no external power consumption for plating. Further, the process is easily scalable for a large recycling plant.

### EXAMPLE 1

Metals of a lithium-ion battery are recovered to form an oxidized conductive element, such as an electrode.

The internal components of the lithium-ion battery are heated in a muffle furnace under a nitrogen atmosphere at a temperature of 800° C. for 8 hours. Following heating, the components are ground with a mortar and pestle and placed in a beaker with aqua regia having a pH of less than 0.5. The solution is stirred for 3 hours to form a recovery solution. The recovery solution is filtered using a ceramic filter to remove the remaining ground components of the lithium-ion battery.

The recovery solution is applied to a single cell galvanic cell using a zinc anode and an aluminum foil cathode. Electroless plating is performed for 5 hours.

The recovered metals, predominantly cobalt and nickel plated on the aluminum foil, are exposed to an oxygen containing atmosphere at 500° C. for 2 hours. A color change indicates plating and oxidation of the plated metals.

### EXAMPLE 2

To perform ashing, a muffle furnace is supplied with an inert gas line (dry nitrogen) in the hood. A pulverized waste sample is placed in a quartz crucible (e.g., 100 gram) and the furnace turned on to ˜1000° C. A dry nitrogen flow is maintained during the heating process.

Under this reducing atmospheric condition, organics break down into carbon ash and graphite. With no oxygen available, formation of CO₂ is suppressed.

The residue from the ashing is treated with strong acid nitric acid to achieve dissolution of the metals, for example, Co and Ni as salts of the metal. This is done in a chemical hood in the lab. Metals from the waste battery components are found to be dissolved in aqua regia. Carbon ash component settles at the bottom of the solution, and the supernatant is taken off to assess the metal recovery by using an ICPMS (Inductively Coupled Plasma Mass Spectrometry). Recovery of 92% of Co and 95% of Ni is found.

Acidic solution with dissolved salts of Co and Ni is pH adjusted to near neutral or slightly acidic to serve as the electrolyte in the plating process. A pH adjustment is done with NH₄OH. The solution is transferred to an electrochemical cell (e.g., a large beaker).

To set up the plating Zn metal is selected to be the reducing agent or anode for the electrochemical cell. The relative potentials of the metal indicate that Zn spontaneously goes into solution, and plates Co and Ni out of the solution. The electrochemical cell is then constructed with:
Electrolyte solution (recovery solution) with Co, Ni salt
Anode Zn rod
Cathode an Al foil
Anode and cathode are separately suspended and dipped into the electrolyte solution.

Anode and cathode electrodes are connected with a conductive wire (alligator clips) external to the electrolyte solution. No external power source is used.

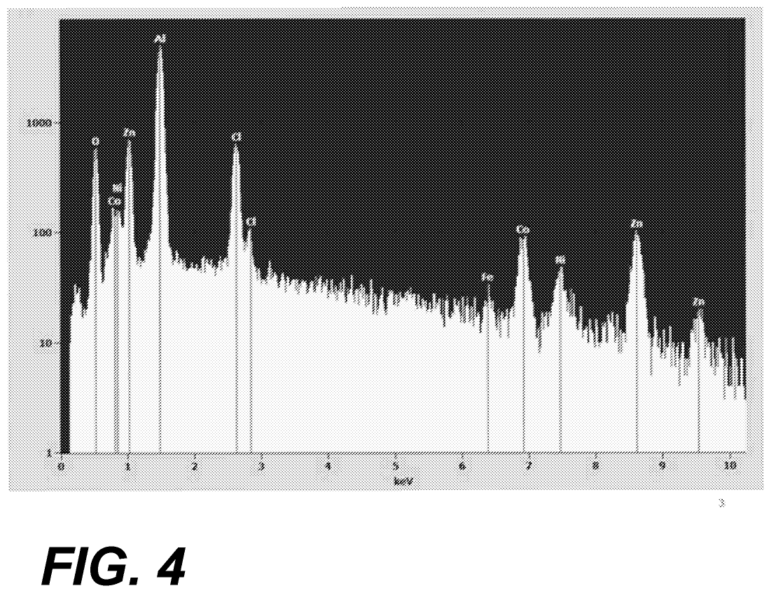

Once this arrangement is complete plating begins, and Co and Ni is plated on the Al foil (cathode). After the plating process, Al foil is removed from the cell and examined for the presence of Co and Ni metal on the surface. Energy Dispersive X-ray Analysis (EDX analysis) of the cathode confirms the presence of Co, Ni. See FIG. 4.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A method for recycling an electrical energy storage device, the method comprising:
exposing components of the electrical energy storage device to an acidic solution to form a recovery solution;
performing plating in the presence of the recovery solution and a conductive substrate, metals of the recovery solution depositing on the conductive substrate; and
oxidizing the metals deposited on the conductive substrate to form an electrode material.

2. The method of claim 1, further comprising heating the components of the electrical energy storage device prior to exposing.

3. The method of claim 2, wherein heating includes heating in an inert atmosphere.

4. The method of claim 3, wherein the inert atmosphere includes nitrogen, argon, or a combination thereof.

5. The method of claim 2, wherein heating includes heating at a temperature in a range of 200° C. to 1200° C.

6. The method of claim 2, wherein heating is performed in a muffle furnace.

7. The method of claim 1, further comprising grinding the components of the electrical energy storage device.

8. The method of claim 7, wherein grinding is performed before heating the components.

9. The method of claim 7, wherein grinding is performed after heating the components and before exposing.

10. The method of claim 1, wherein the acidic solution includes aqua regia, hydrochloric acid, sulfuric acid, nitric acid, or a combination thereof.

11. The method of claim 10, wherein the acidic solution includes aqua regia.

12. The method of claim 1, wherein the acidic solution has a pH of less than 1.5.

13. The method of claim 1, wherein the conductive substrate includes copper, gold, silver, platinum, titanium, aluminum, graphite, or a combination thereof.

14. The method of claim 13, wherein the conductive substrate is graphite.

15. The method of claim 13, wherein the conductive substrate includes aluminum.

16. The method of claim 1, wherein the conductive substrate is a foil.

17. The method of claim 1, wherein plating include electroless plating.

18. The method of claim 1, wherein plating is performed in a galvanic cell.

19. The method of claim 18, wherein the galvanic cell is free of an external electric potential source.

20. The method of claim 1, wherein oxidizing includes heating in an oxygen containing atmosphere at a temperature in a range of 200° C. to 1000° C.
